(19) United States
(12) Patent Application Publication
(10) Pub. No.: US 2009/0237309 A1
(43) Pub. Date: Sep. 24, 2009

(54) RADIO APPARATUS AND ANTENNA DEVICE INCLUDING ANISOTROPIC DIELECTRIC MATERIAL

(75) Inventors: Isao OHBA, Tokyo (JP); Takashi Amano, Saitama-ken (JP); Satoshi Mizoguchi, Tokyo (JP); Koichi Sato, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/368,455

(22) Filed: Feb. 10, 2009

(30) Foreign Application Priority Data
Mar. 24, 2008 (JP) 2008-75228

(51) Int. Cl. H01Q 1/38; H01Q 21/00

(52) U.S. Cl. 343/700 MS; 343/893

(57) ABSTRACT

A radio apparatus having a printed board and an antenna element is provided. The antenna element is configured to be fed at a feed portion provided in the printed board. The antenna element includes a portion arranged parallel to the printed board. The anisotropic dielectric material is arranged in such a way that a direction of a maximum permittivity value of the anisotropic dielectric material equals a direction of the portion of the antenna element arranged parallel to the printed board. The anisotropic dielectric material is arranged in contact with the portion of the antenna element arranged parallel to the printed board.

### CROSS REFERENCE TO RELATED APPLICATIONS

This application is based upon and claims the benefit of priority from the prior Japanese Patent Application No. 2008-75228 filed on Mar. 24, 2008; the entire contents of which are incorporated herein by reference.

### BACKGROUND OF THE INVENTION

1. Field of the Invention

The present invention relates to a radio apparatus and an antenna device, and in particular to an antenna device including dielectric material for isolation and a radio apparatus having the antenna device.

2. Description of the Related Art

Radio apparatuses such as mobile phones are required to be downsized, and thus, e.g., a mobile radio apparatus having an antenna loaded with dielectric material so as to be downsized due to a wavelength shortening effect is disclosed in Japanese Patent Publication of Unexamined Applications (Kokai), No. 2007-201633.

The mobile radio apparatus disclosed in JP 2007-201633 has a water-tight packing made of dielectric material and arranged in contact with an antenna. According to JP 2007-201633, the water-tight packing made of dielectric material may contribute to downsizing of the antenna by shortening a wavelength of an electromagnetic wave sent or received by the antenna. The water-tight packing may have an effect of preventing an alien substance such as a drop of water from entering a casing of the mobile radio apparatus.

Meanwhile, a radio apparatus including a dielectric material of a high permittivity value is disclosed in Japanese Patent Publication of Unexamined Applications (Kokai), No. 2004-208084. The radio apparatus of JP 2004-208084 is configured to control directivity of an antenna loaded with the dielectric material by using an effect of concentrating more energy of an electric field as the permittivity value is higher.

According to JP 2004-208084, the antenna is loaded with dielectric material of relatively high permittivity and extremely low loss on the opposite side to a human body. The antenna may concentrate the energy of the electric field of an electromagnetic wave sent or received by the antenna on the portion loaded with the dielectric material, thereby. In some cases, the antenna may have directivity in an opposite direction to the human body by forming a curvature on a surface of the dielectric material so that the electromagnetic wave may pass through the curvature.

In a case where dielectric material is arranged in the casing such as in the mobile radio apparatus of JP 2007-201633, the electric field concentration between a ground conductor, a metallic portion or material arranged in the casing and the antenna through the dielectric material may cause a stronger coupling. Thus, there may be a problem in that a value of antenna impedance is likely to decrease, or that a resonant frequency is likely to deviate.

The mobile phone of JP 2004-208084 has an antenna element loaded with the dielectric material that is half-sphere or half-cylinder shaped towards the outside of the casing. Such a configuration may limit a location of the dielectric material, thus causing limitation on an arrangement design. Thus, there may be a problem in that the configuration is not necessarily useful for downsizing of the mobile phone.

### SUMMARY OF THE INVENTION

Accordingly, an advantage of the present invention is to have a wavelength shortening effect of an antenna of a radio apparatus loaded with dielectric material, and to simultaneously suppress a coupling between the antenna and circuits or portions surrounding the antenna with less limitation on the arrangement design.

To achieve the above advantage, one aspect of the present invention is to provide a radio apparatus having a printed board and an antenna element. The antenna element is configured to be fed at a feed portion provided in the printed board. The antenna element includes a portion arranged parallel to the printed board. The anisotropic dielectric material is arranged in such a way that a direction of a maximum permittivity value of the anisotropic dielectric material equals a direction of the portion of the antenna element arranged parallel to the printed board. The anisotropic dielectric material is arranged in contact with the portion of the antenna element arranged parallel to the printed board.

### BRIEF DESCRIPTION OF THE DRAWINGS

FIG. 1 is a perspective view of main portions of a radio apparatus of a first embodiment of the present invention.

FIG. 2 is a perspective view showing a configuration and dimensions of a model used for an experiment.

FIG. 3 is a perspective view showing a configuration and dimensions of another model used for the experiment.

FIG. 4 is a graph of VSWR-frequency characteristics of an antenna element of each of the models shown in FIG. 2 and FIG. 3 estimated by the experiment.

FIG. 5 is a graph of VSWR-frequency characteristics of the antenna element of each of the models shown in FIG. 2 and FIG. 3 estimated by a simulation.

FIG. 6 is a perspective view of main portions of a radio apparatus of a second embodiment of the present invention.

FIG. 7 is a perspective view of main portions of a radio apparatus of a third embodiment of the present invention.

FIG. 8 is a perspective view of main portions of a radio apparatus of a fourth embodiment of the present invention.

### DETAILED DESCRIPTION OF THE INVENTION

Hereinafter, embodiments of the present invention will be described in detail. In following descriptions, terms such as upper, lower, left, right, horizontal or vertical used while referring to a drawing shall be interpreted on a page of the drawing unless otherwise noted. A same reference numeral given in no less than two drawings shall represent a same member or a same portion.

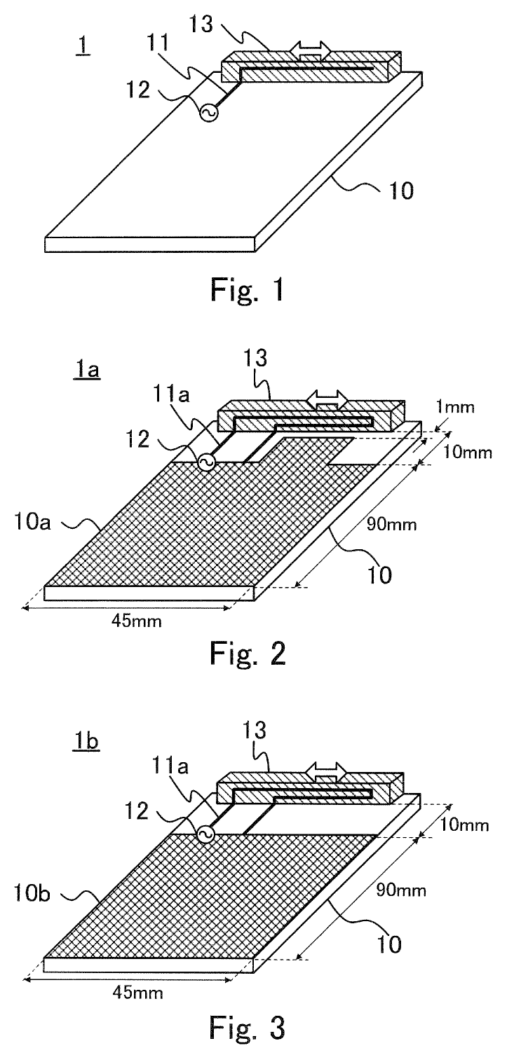

A first embodiment of the present invention will be described with reference to FIGS. 1-5. FIG. 1 is a perspective view of main portions of a radio apparatus 1 of the first embodiment. The radio apparatus 1 has a printed board 10 contained in a casing (not shown) of the radio apparatus 1, and an antenna element 11. The printed board 10 includes a conductive pattern that is not shown and given a ground level voltage while the radio apparatus 1 is working. The conductive pattern is hereafter called the ground conductor.

As shown in FIG. 1, the antenna element 11 is depicted as nearly L-shaped. The antenna element 11 may be fed, at an end connected to a feed portion 12, by a radio circuit that is provided in the printed board 10 and is not shown. Another end of the antenna element 11 is, e.g., open ended as shown in FIG. 1. A portion of the antenna element 11 including the open end is arranged parallel to the printed board 10. The term “parallel” used here and hereafter means not exactly but almost parallel as well as exactly parallel, and so is the term “equal” hereafter.

The radio apparatus 1 has an anisotropic dielectric material 13 made of material having a relatively high permittivity value in a specific direction in three-dimensional space, and a relatively low permittivity value in remaining directions (i.e., anisotropic permittivity). The anisotropic dielectric material 13 is arranged in contact with a portion of the antenna element 11 arranged parallel to the printed board 10. In other words, the antenna element 11 is loaded with the anisotropic dielectric material 13. The anisotropic dielectric material 13 is arranged in such a way that a direction of a maximum permittivity value (as shown by a block arrow in FIG. 1) is equal to the direction of the portion of the antenna element 11 arranged parallel to the printed board 10.

If the antenna element 11 is fed at the feed portion 12, a resonant wavelength of a radio frequency voltage or current distributed along a line of the antenna element 11 may be shortened to a value determined by the maximum permittivity value of the anisotropic dielectric material 13. As the (maximum) permittivity value is higher, the wavelength shortening effect is more obvious.

Meanwhile, the ground conductor of the printed board 10 and the open end portion of the antenna element 11 arranged parallel to each other may produce capacitance between each other so as to be coupled through the capacitance with each other. As the permittivity value of the anisotropic dielectric material 13 in a direction from the antenna element 11 to the printed board 10 (i.e., perpendicular to the direction of the block arrow shown in FIG. 1) is lower, the above coupling is weaker. The above coupling may reduce the impedance of the antenna element 11 so as to shift the resonant frequency to a lower frequency range. Thus, as the above coupling is weaker, such a shift of the resonant frequency may be suppressed more.

Qualitatively speaking, as the anisotropy of the anisotropic dielectric material 13 is more obvious (i.e., a ratio of the permittivity in the direction of the block arrow shown in FIG. 1 to the permittivity in the remaining directions (called a high-to-low ratio of the permittivity) is greater), the cost of the wavelength shortening effect such as a decrease in impedance or a shift of the resonant frequency may be reduced.

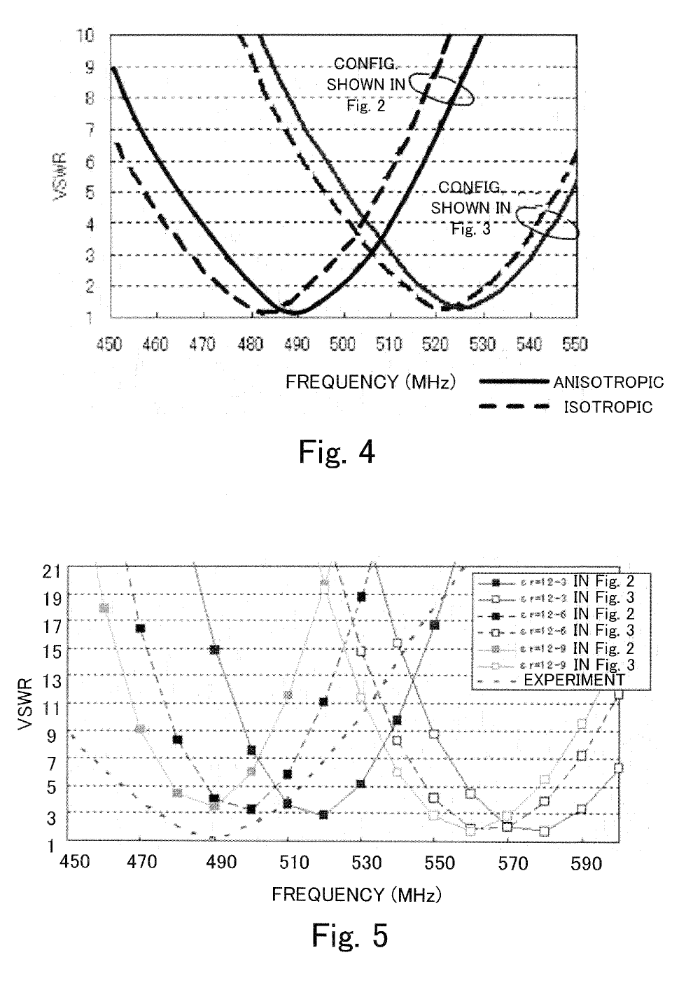

An effect of the first embodiment estimated by an experiment and by a simulation will be described with reference to FIGS. 2-5. FIG. 2 is a perspective view showing a configuration and dimensions of a model (called a radio apparatus 1a) used for the experiment. FIG. 3 is a perspective view showing a configuration and dimensions of another model (called a radio apparatus 1b) used for the experiment.

The radio apparatus la shown in FIG. 2 has the printed board 10 and the anisotropic dielectric material 13 which are same as shown in FIG. 1. The anisotropic dielectric material 13 is arranged in an end portion of the printed board 10. The direction of the maximum permittivity value is shown by a block arrow, as in FIG. 1. An area of a ground conductor 10aof the printed board 10 is indicated by cross-hatching.

The antenna device la has an antenna element that is slightly different from the antenna element 11 shown in FIG. 1 with respect to a shape and a connection, and thus given a reference numeral 11a. The antenna element 11a may be fed at the feed portion 12 (same as the corresponding one shown in FIG. 1) provided around an upper side of the ground conductor 10a that is closer to the anisotropic dielectric material 13. The antenna element 11 a is arranged in contact with the anisotropic dielectric material 13 and to turn back. The antenna element 11a has a grounded end short-circuited to the ground conductor 10a.

As shown in FIG. 2, the ground conductor 10a has a portion of an upper end shaped sticking out towards the anisotropic dielectric material 13. The shape of the above portion imitates a configuration that a metallic component of a mobile phone, e.g., a speaker, is arranged close to an antenna. In this case, the direction of the maximum permittivity value shown by the block arrow may be parallel to a portion of the metallic component facing the antenna element 11a.

As shown in FIG. 2, there is a space of 1 millimeters (mm) between the anisotropic dielectric material 13 and the above sticking-out portion of the ground conductor 10a. There is a space of 10 mm between the anisotropic dielectric material 13 and the remaining portion of the upper end of the ground conductor 10a. The ground conductor 10a is 90 mm long between the remaining portion of the upper end and a lower end (i.e., a lower end of the printed board 10). The ground conductor 10a (and the printed board 10) is 45 mm wide.

The radio apparatus 1b shown in FIG. 3 has the printed board 10, the anisotropic dielectric material 13 and the antenna element 11 a which are same as shown in FIG. 1. The anisotropic dielectric material 13 is arranged in an end portion of the printed board 10. The direction of the maximum permittivity value is shown by a block arrow, as in FIG. 1. An area of a ground conductor 10b of the printed board 10 is indicated by cross-hatching.

The ground conductor 10b is shaped differently from the ground conductor 10a without a sticking-out portion of an upper end. The antenna element 11a may be fed at the feed portion 12 (i.e., a same as shown in FIG. 1 or FIG. 2). The antenna element 11a has a grounded end short-circuited to the ground conductor 10b.

As shown in FIG. 3, there is a space of 10 mm between the anisotropic dielectric material 13 and the upper end of the ground conductor 10b. The ground conductor 10b is 90 mm long between the upper end and a lower end (i.e., a lower end of the printed board 10). The ground conductor 10b (and the printed board 10) is 45 mm wide.

FIG. 4 is a graph of voltage standing wave ratio (VSWR) vs. frequency characteristics of the antenna element 11a of the radio apparatuses 1a and 1b estimated by experiment. FIG. 4 has a horizontal axis and a vertical axis representing frequencies (in megahertz (MHz)) and the VSWR, respectively.

In FIG. 4, a solid curve on a left side represents a characteristic of the radio apparatus 1a shown in FIG. 2. A dashed curve on the left side represents a characteristic of the radio apparatus 1a shown in FIG. 2 on an assumption that the anisotropic dielectric material 13 is replaced by an isotropic dielectric material.

In FIG. 4, a solid curve on a right side represents a characteristic of the radio apparatus 1b shown in FIG. 3. A dashed curve on the right side represents a characteristic of the radio apparatus 1b shown in FIG. 3 on an assumption that the anisotropic dielectric material 13 is replaced by an isotropic dielectric material.

The anisotropic dielectric material 13 used for the experiment has, e.g., a relative permittivity value of 12 in the direction of the maximum permittivity value, and a relative permittivity value of 9 in the remaining directions. The isotropic dielectric material used for the experiment has, e.g., a relative permittivity value of 7. The antenna element 11a is given a length so that, e.g., a resonant frequency of the configuration shown in FIG. 3 loaded with the isotropic dielectric material (corresponding to the dashed curve on the right side of FIG. 4) is 520 MHz.

A comparison of the solid and dashed curves on the right side of FIG. 4 shows that the resonant frequency changes by a few MHz depending on whether the dielectric material that the antenna element 11a is loaded with is isotropic or anisotropic, and that the change is smaller than a change of the resonant frequency between the solid and dashed curves on the left side of FIG. 4 (nearly 10 MHz). What is described above may be explained as follows.

As the space between the antenna element 11a and the ground conductor 10b in the configuration of the radio apparatus 1b shown in FIG. 3 is relatively great, there is a relatively weak coupling through the capacitance produced between the antenna element 11a and the ground conductor 10b. Thus, the resonant frequency of the radio apparatus 1b may be relatively less affected by a degree of concentration of the energy of the electric field in the direction perpendicular to the block arrow (i.e., by the difference of the permittivity in the above direction).

Meanwhile, as the space between the antenna element 11a and the ground conductor 10a in the configuration of the radio apparatus 1a shown in FIG. 2, corresponding to the solid and dashed curves on the left side of FIG. 4, is relatively small, there is a relatively strong coupling produced between the antenna element 11a and the ground conductor 10a through the capacitance. Thus, the resonant frequency of the radio apparatus 1a may be more affected by the degree of concentration of the energy of the electric field in the direction perpendicular to the block arrow (i.e., by the difference of the permittivity in the above direction).

In the configuration of the radio apparatus 1a shown in FIG. 2, the permittivity value is smaller in the direction perpendicular to the block arrow so that the coupling is made weaker in a case where the anisotropic dielectric material 13 is used (represented by the solid curve on the left side of FIG. 4) than in a case where the isotropic dielectric material is used (represented by the dashed curve on the left side of FIG. 4). Thus, the use of the anisotropic dielectric material 13 may suppress a downward shift of the resonant frequency.

A comparison between the use of the anisotropic dielectric material 13 (represented by the solid curve on the right side of FIG. 4) and the use of the isotropic dielectric material (represented by the dashed curve on the right side of FIG. 4) may produce a similar result in the configuration of the radio apparatus 1b.

Both in FIG. 2 and in FIG. 3, the permittivity of the dielectric material that the antenna element 11a is loaded with in the direction of the block arrow does not change depending on whether the dielectric material is anisotropic or isotropic, and neither does the wavelength shortening effect. That is, producing the same wavelength shortening effect as the use of the isotropic dielectric material, the use of the anisotropic dielectric material 13 may suppress the coupling between the antenna element and the ground conductor of the printed board or metallic components, and may suppress the resultant downward shift of the resonant frequency.

Both in FIG. 2 and in FIG. 3, it is proved by the experiment that a measured value of radiation efficiency less changes depending on whether the dielectric material is anisotropic or isotropic.

The permittivity value of the anisotropic dielectric material 13 used for the experiment illustrated in FIG. 4 has a high-to-low ratio (i.e., a ratio of the maximum value in the direction of anisotropy to the value in the remaining directions) of 7 to 3. FIG. 5 is a graph of voltage standing wave ratio (VSWR)-frequency characteristics of the antenna element 11a of the radio apparatus 1a and 1b estimated by a simulation given several values of the high-to-low ratio as a variable parameter. FIG. 5 has a horizontal axis and a vertical axis representing frequencies (in MHz) and the VSWR, respectively.

In FIG. 5, a dashed curve without plots is a same as the solid curve on the left side of FIG. 4 representing the experiment data for reference. Three curves with filled square plots represent characteristics of the radio apparatus 1a shown in FIG. 2. A right-hand one of the above curves (showing a resonant frequency of nearly 520 MHz) is obtained given the relative permittivity value of 12 in the direction of the maximum permittivity value and the relative permittivity value of 3 in the remaining directions.

A middle one of the above curves (showing a resonant frequency of nearly 500 MHz) is obtained given the relative permittivity value of 12 in the direction of the maximum permittivity value and the relative permittivity value of 6 in the remaining directions. A left-hand one of the above curves (showing a resonant frequency of nearly 490 MHz) is obtained given the relative permittivity value of 12 in the direction of the maximum permittivity value and the relative permittivity value of 9 in the remaining directions.

In FIG. 5, three curves with blank square plots represent characteristics of the radio apparatus 1 b shown in FIG. 3. A right-hand one of the above curves (showing a resonant frequency of nearly 580 MHz) is obtained given the relative permittivity value of 12 in the direction of the maximum permittivity value and the relative permittivity value of 3 in the remaining directions.

A middle one of the above curves (showing a resonant frequency of nearly 570 MHz) is obtained given the relative permittivity value of 12 in the direction of the maximum permittivity value and the relative permittivity value of 6 in the remaining directions. A left-hand one of the above curves (showing a resonant frequency of nearly 560 MHz) is obtained given the relative permittivity value of 12 in the direction of the maximum permittivity value and the relative permittivity value of 9 in the remaining directions.

Differences of the resonant frequencies among the three curves with the filled plots are greater than differences of the resonant frequencies among the three curves with the blank plots, for a same reason (the width of the space between the antenna element 11a and the ground conductor 10a or 10b) as explained with reference to FIG. 4.

A comparison of the three curves with the filled plots with one another shows that the coupling between the antenna element 11a and the ground conductor 10a is made weaker as the high-to-low ratio of the permittivity is higher, and thus the downward shift of the resonant frequency may be suppressed. A comparison of the three curves with the blank plots with one another shows that the coupling between the antenna element 11a and the ground conductor 10b is made weaker as the high-to-low ratio of the permittivity is higher, and thus the downward shift of the resonant frequency may be suppressed.

According to the first embodiment of the present invention described above, producing almost a same wavelength shortening effect as loaded with an isotropic dielectric material, the antenna device having the antenna element loaded with the anisotropic dielectric material may suppress a coupling with a printed board and so forth and a downward shift of a resonant frequency.

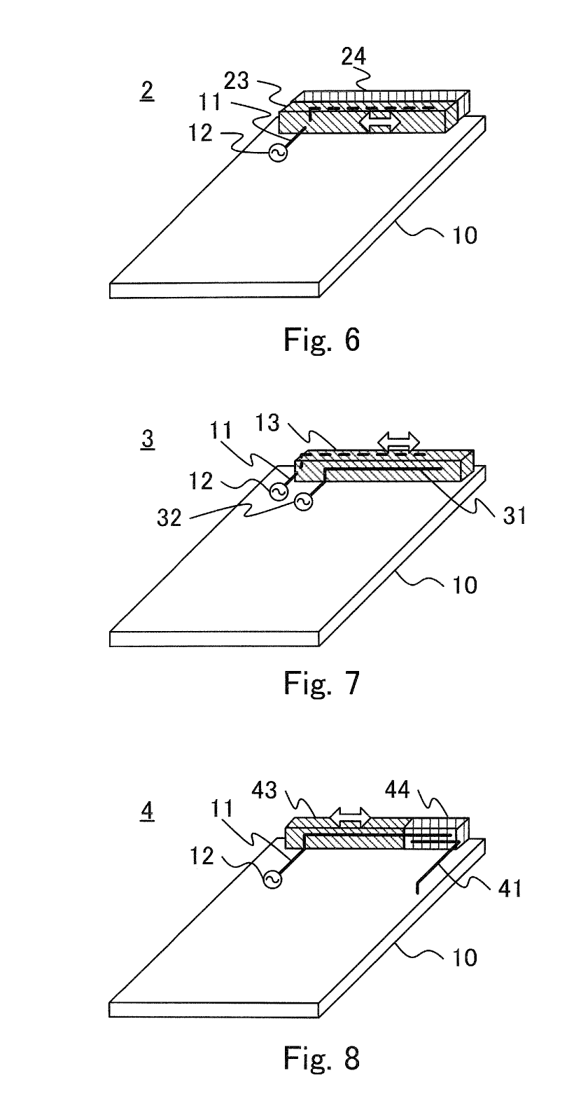

A second embodiment of the present invention will be described with reference to FIG. 6, a perspective view of main portions of a radio apparatus 2 of the second embodiment. The radio apparatus 2 has a printed board 10 contained in a casing (not shown) of the radio apparatus 2, and an antenna element 11 that may be fed at a feed portion 12 (each of these portions is a same as the corresponding one of the first embodiment given the same reference numeral).

The radio apparatus 2 has an anisotropic dielectric material 23 and an isotropic dielectric material 24. The anisotropic dielectric material 23 is arranged in contact with a portion of the antenna element 11 arranged parallel to the printed board 10 towards the inside of the printed board 10. The anisotropic dielectric material 23 is arranged in such a way that a direction of a maximum permittivity value (as shown by a block arrow in FIG. 6) is equal to the direction of the portion of the antenna element 11 arranged parallel to the printed board 10.

Meanwhile, the isotropic dielectric material 24 is arranged in contact with the portion of the antenna element 11 arranged parallel to the printed board 10 towards the outside of the printed board 10. In other words, the portion of the antenna element 11 arranged parallel to the printed board 10 is arranged between the anisotropic dielectric material 23 and the isotropic dielectric material 24.

In FIG. 6, being fed at the feed portion 12, the antenna element 11 may have a wavelength shortening effect determined by permittivity of the anisotropic dielectric material 23 in the direction of the block arrow and permittivity of the isotropic dielectric material 24.

Meanwhile, as the permittivity value of the anisotropic dielectric material 23 in the direction perpendicular to the direction of the block arrow shown in FIG. 6 is lower, a coupling between the ground conductor of the printed board 10 and the open end portion of the antenna element 11, which are parallel to each other, is weaker. That is, due to the anisotropic permittivity of the anisotropic dielectric material 23, the antenna element 11 may have a wavelength shortening effect and may suppress a shift of the resonant frequency caused by the coupling with the ground conductor of the printed board 10 and so forth.

As the portion of the antenna element 11 arranged parallel to the printed board 10 is loaded with the isotropic dielectric material 24 arranged towards the outside of the printed board 10, the antenna element 11 may concentrate energy of an electric field going to outside space of the radio apparatus 2 and may enforce electromagnetic field radiation to the outside space of the radio apparatus 2, thereby.

According to the second embodiment of the present invention described above, the radio apparatus may obtain an additional effect of the enforced electromagnetic field radiation to the outside space.

A third embodiment of the present invention will be described with reference to FIG. 7, a perspective view of main portions of a radio apparatus 3 of the third embodiment. The radio apparatus 3 has a printed board 10 contained in a casing (not shown) of the radio apparatus 3, and an antenna element 11 that may be fed at a feed portion 12. The radio apparatus 3 has an anisotropic dielectric material 13 that the antenna element 11 is loaded with.

Each of these portions is a same as the corresponding one of the first embodiment given the same reference numeral. As the antenna element 11 is loaded with the anisotropic dielectric material 13 arranged towards the inside of the printed board 10, a portion of the antenna element 11 located behind the anisotropic dielectric material 13 in FIG. 7 is shown by dashed lines. The direction of the maximum permittivity value of the anisotropic dielectric material 13 is indicated by the same block arrow as shown in FIG. 1.

The radio apparatus 3 has an additional antenna element 31 in addition to the antenna element 11. The additional antenna element 31 may be fed, at an end connected to a feed portion 12, by a radio circuit (provided for a system that is different from the radio circuit configured to feed the antenna element 11) that is provided in the printed board 10 and is not shown. Another end of the antenna element 11 is, e.g., open ended as shown in FIG. 7.

The additional antenna element 31 has a portion including the open end, and arranged parallel to and to face a portion of the antenna element 11 including the open end. In other words, the anisotropic dielectric material 13 is arranged in such a way that the direction of the maximum permittivity value (as shown by a block arrow in FIG. 7) is equal to the direction of the portion of the antenna element 11 facing the antenna element 11. In FIG. 7, being fed at the feed portion 12, the antenna element 11 may have a wavelength shortening effect determined by the permittivity of the anisotropic dielectric material 13 in the direction of the block arrow.

Meanwhile, as the permittivity value of the anisotropic dielectric material 13 in the direction perpendicular to the direction of the block arrow shown in FIG. 7 is lower, a coupling between the open end portion of the additional antenna element 31 and the open end portion of the antenna element 11, which are parallel to each other, is weaker. That is, producing a wavelength shortening effect of the antenna element 11, the use of the anisotropic dielectric material 13 may suppress a coupling between different systems through the coupling between the antenna element 11 and the additional antenna element 31.

According to the third embodiment of the present invention described above, an additional effect of suppressing interference between different systems may be obtained.

A fourth embodiment of the present invention will be described with reference to FIG. 8, a perspective view of main portions of a radio apparatus 4 of the fourth embodiment. The radio apparatus 4 has a printed board 10 contained in a casing (not shown) of the radio apparatus 4, and an antenna element 11 that may be fed at a feed portion 12 (each of these portions is a same as the corresponding one of the first embodiment given the same reference numeral).

The radio apparatus 4 has an additional antenna element 41 in addition to the antenna element 11. The additional antenna element 41 is a parasitic element having, e.g., an open end and an opposite end short-circuited to the ground conductor of the printed board 10. A portion of the additional antenna element 41 including the open end is arranged parallel to the antenna element 11.

The radio apparatus 4 has an anisotropic dielectric material 43 arranged in contact with a portion of the antenna element 11 arranged parallel to the printed board 10. The anisotropic dielectric material 43 is arranged in such a way that a direction of a maximum permittivity value (as shown by a block arrow in FIG. 8) is equal to the direction of the portion of the antenna element 11 arranged parallel to the printed board 10.

The radio apparatus 4 has an anisotropic dielectric material 44 arranged in contact with the antenna element 11 around the additional antenna element 41.

In FIG. 8, being fed at the feed portion 12, the antenna element 11 may have a wavelength shortening effect determined by the permittivity of the anisotropic dielectric material 43 in the direction of the block arrow.

Due to the anisotropic permittivity of the anisotropic dielectric material 43, the antenna element 11 may suppress a shift of the resonant frequency caused by the coupling with the ground conductor of the printed board 10 and so forth.

Meanwhile, as the isotropic dielectric material 24 is arranged in contact with and loaded onto the antenna element 11, the antenna element 11 and the additional antenna element 41 may concentrate energy of an electric field between each other and may enforce a mutual coupling thereby.

The radio apparatus 4 may have an antenna element of a different system arranged close to the anisotropic dielectric material 43. In such a configuration, while the isotropic dielectric material 43 may enforce the coupling between the antenna element 11 and the additional antenna element 41, the anisotropic dielectric material 43 may suppress a coupling between the antenna element 11 and the antenna element of the different system. Strength of each of the couplings may be optionally selected thereby.

According to the fourth embodiment of the present invention described above, an additional effect of an enforced coupling with an additional antenna element may be obtained.

In the above description of the embodiments, the configurations, shapes, dimensions, connections or positional relations of the antenna devices, the materials such as the dielectric materials, the printed boards, etc. are considered as exemplary only, and thus may be variously modified within the scope of the present invention.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. A radio apparatus, comprising:
a printed board;
an antenna element configured to be fed at a feed portion provided in the printed board, the antenna element including a portion arranged parallel to the printed board; and
an anisotropic dielectric material arranged in such a way that a direction of a maximum permittivity value of the anisotropic dielectric material equals a direction of the portion of the antenna element arranged parallel to the printed board, the anisotropic dielectric material arranged in contact with the portion of the antenna element arranged parallel to the printed board.

2. The radio apparatus of claim 1, further comprising a conductive material arranged close to the antenna element, the conductive material including a portion facing the antenna element, wherein the anisotropic dielectric material is arranged in such a way that the direction of the maximum permittivity value of the anisotropic dielectric material is parallel to the portion of the conductive material facing the antenna element.

3. The radio apparatus of claim 1, further comprising an isotropic dielectric material, wherein
the antenna element is arranged close to an end portion of the printed board,
the anisotropic dielectric material is arranged in contact with the portion of the antenna element arranged parallel to the printed board towards the inside of the printed board, and
the isotropic dielectric material is arranged in contact with the portion of the antenna element arranged parallel to the printed board from a side towards the outside of the printed board.

4. The radio apparatus of claim 1, further comprising an additional antenna element including a portion facing the antenna element, wherein the anisotropic dielectric material is arranged in such a way that the direction of the maximum permittivity value of the anisotropic dielectric material is parallel to the portion of the additional antenna element facing the antenna element.

5. The radio apparatus of claim 1, further comprising
an additional antenna element including a portion facing the antenna element, and
an isotropic dielectric material arranged in contact with the antenna element around the additional antenna element.

6. The radio apparatus of claim 1, further comprising
a first additional antenna element including a first portion facing the antenna element,
a second additional antenna element including a second portion facing the antenna element and
an isotropic dielectric material arranged in contact with the antenna element around the second additional antenna element, wherein
the anisotropic dielectric material is arranged in such a way that the direction of the maximum permittivity value of the anisotropic dielectric material is parallel to the first portion of the first additional antenna element.

7. The radio apparatus of claim 5, wherein the additional antenna element is a parasitic element.

8. The radio apparatus of claim 6, wherein the second additional antenna element is a parasitic element.

9. An antenna device included in a radio apparatus having a printed board, comprising:
an antenna element configured to be fed at a feed portion provided in the printed board, the antenna element including a portion arranged parallel to the printed board; and
an anisotropic dielectric material arranged in such a way that a direction of a maximum permittivity value of the anisotropic dielectric material equals a direction of the portion of the antenna element arranged parallel to the printed board, the anisotropic dielectric material arranged in contact with the portion of the antenna element arranged parallel to the printed board.

10. The antenna device of claim 9, wherein
the radio apparatus further has a conductive material arranged close to the antenna element, the conductive material including a portion facing the antenna element, and
the anisotropic dielectric material is arranged in such a way that the direction of the maximum permittivity value of the anisotropic dielectric material is parallel to the portion of the conductive material facing the antenna element.

11. The antenna device of claim 9, further comprising an isotropic dielectric material, wherein
the antenna element is arranged close to an end portion of the printed board,
the anisotropic dielectric material is arranged in contact with the portion of the antenna element arranged parallel to the printed board towards the inside of the printed board, and
the isotropic dielectric material is arranged in contact with the portion of the antenna element arranged parallel to the printed board from a side towards the outside of the printed board.

12. The antenna device of claim 9, wherein
the radio apparatus further has an additional antenna element including a portion facing the antenna element, and
the anisotropic dielectric material is arranged in such a way that the direction of the maximum permittivity value of the anisotropic dielectric material is parallel to the portion of the additional antenna element facing the antenna element.

13. The antenna device of claim 9, further comprising an isotropic dielectric material, wherein
the radio apparatus has an additional antenna element including a portion facing the antenna element, and
the isotropic dielectric material is arranged in contact with the antenna element around the additional antenna element.

14. The antenna device of claim 9, further comprising an isotropic dielectric material, wherein
the radio apparatus further has a first additional antenna element including a first portion facing the antenna element and a second additional antenna element including a second portion facing the antenna element, wherein
the anisotropic dielectric material is arranged in such a way that the direction of the maximum permittivity value of the anisotropic dielectric material is parallel to the first portion of the first additional antenna element, and
the isotropic dielectric material is arranged in contact with the antenna element around the second additional antenna element.

15. The antenna device of claim 13, wherein the additional antenna element is a parasitic element.

16. The antenna device of claim 14, wherein the second additional antenna element is a parasitic element.
